(19) United States
(12) Patent Application Publication
(10) Pub. No.: US 2026/0371139 A1
(43) Pub. Date: Nov. 19, 2026

(54) Methods And Apparatus For Artificial Intelligence Mobility Configuration In Mobile Communications

(71) Applicant: MediaTek Singapore Pte. Ltd., Singapore (SG)

(72) Inventors: Yao Peng, Beijing (CN); Ta-Yuan Liu, Hsinchu City (TW); Yuanyuan Zhang, Beijing (CN)

(73) Assignee: MediaTek Singapore Pte. Ltd., Singapore (SG)

(21) Appl. No.: 19/668,745

(22) Filed: May 5, 2026

(30) Foreign Application Priority Data
May 14, 2025 (WO) PCT/CN2025/094897

(51) Int. Cl. H04W 24/10; G06N 5/04

(52) U.S. Cl. CPC H04W 24/10; G06N 5/04

(57) ABSTRACT

Various solutions for artificial intelligence (AI) mobility configuration with respect to an apparatus and a network are described. An apparatus may receive a configuration for artificial intelligence (AI) mobility from a network node. The configuration comprises a training data configuration, an inference configuration, and a monitoring configuration. The apparatus may perform a measurement according to the configuration.

### CROSS REFERENCE TO RELATED PATENT APPLICATION(S)

The present disclosure is part of a non-provisional application claiming the priority benefit of PCT Application No. PCT/CN2025/094897, filed 14 May. 2025, the content of which is herein incorporated by reference in its entirety.

### TECHNICAL FIELD

The present disclosure is generally related to mobile communications and, more particularly, to artificial intelligence (AI) mobility configuration with respect to an apparatus and a network node in mobile communications.

### BACKGROUN

Unless otherwise indicated herein, approaches described in this section are not prior art to the claims listed below and are not admitted as prior art by inclusion in this section.

Wireless communication systems may be widely deployed to provide various telecommunication services such as telephony, video, data, messaging, and broadcasts. Typical wireless communication systems may use multiple-access technologies capable of supporting communication with multiple users by sharing available system resources. Examples of such multiple-access technologies may include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

In communication technologies, artificial intelligence (AI) and machine learning (ML) have been widely used in wireless networks to improve performance, user experience, and reduce complexity and overhead. In the conventional network of the 3rd generation partnership project (3GPP) 5G new radio (NR), the AI or ML technology is leveraged to address the challenges due to the increased complexity of foreseen deployments over the air interface, both for the network nodes and user equipments (UEs). AI mobility may be considered. The network node may need to provide the necessary configuration to the UE to support the AI feature.

Accordingly, how to perform the AI mobility configuration becomes an important issue for the newly developed wireless communication network. Therefore, there is a need to provide proper schemes for the AI mobility configuration.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods, and apparatus pertaining to artificial intelligence (AI) mobility configuration with respect to an apparatus and a network node in mobile communications. It is believed that the above-described issue would be avoided or otherwise alleviated by implementing one or more of the proposed schemes described herein.

In one aspect, a method may involve an apparatus receiving a configuration for AI mobility from a network node. The configuration may comprise a training data configuration, an inference configuration, and a monitoring configuration. The method may also involve the apparatus performing a measurement according to the configuration.

In another aspect, a method may involve a network node transmitting for AI mobility to a user equipment (UE). The configuration may comprise a training data configuration, an inference configuration, and a monitoring configuration. The method may also involve the network node receiving a measurement report from the UE based on the configuration.

In another aspect, an apparatus may involve a transceiver which, during operation, communicates with a network. The apparatus may also involve a processor communicatively coupled to the transceiver such that, during operation, the processor may receive, via the transceiver, a configuration for AI mobility from the network node. The configuration may comprise a training data configuration, an inference configuration, and a monitoring configuration. The processor may also perform a measurement according to the configuration.

It is noteworthy that, although description provided herein may be in the context of certain radio access technologies, networks and network topologies such as 5^{th} Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), 6th Generation (6G), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario for a communication system in accordance with implementations of the present disclosure.

FIG. 3 is a diagram depicting an example scenario for a configuration structure in accordance with implementations of the present disclosure.

FIG. 4 is a diagram depicting an example scenario for a mapping for training data configuration in accordance with implementations of the present disclosure.

FIG. 5 is a diagram depicting an example scenario for a structure for configuration of TrainDataIdToAddModList and TrainDataIdToAddMod in accordance with implementations of the present disclosure.

FIG. 6 is a diagram depicting an example scenario for a configuration of MeasObject and LoggedConfig in accordance with implementations of the present disclosure.

FIG. 7 is a diagram depicting an example scenario for procedures for periodical logged and event trigger logged during UE mobility in accordance with implementations of the present disclosure.

FIG. 8 is a diagram depicting an example scenario for a structure of inference configuration in accordance with implementations of the present disclosure.

FIG. 9 is a diagram depicting an example scenario for a mapping for inference configuration in accordance with implementations of the present disclosure.

FIGS. 10A-10B is a diagram depicting an example scenario for a structure for configurations of InferenceIdToAddMod, predObjectId, and ReportConfigId in accordance with implementations of the present disclosure.

FIG. 11 is a diagram depicting an example scenario for a structure of monitoring configuration in accordance with implementations of the present disclosure.

FIG. 12 is a diagram depicting an example scenario for a mapping for monitoring configuration in accordance with implementations of the present disclosure.

FIG. 13 is a diagram depicting an example scenario for a structure for configuration of MonitorIdToAddMod in accordance with implementations of the present disclosure.

FIG. 14 is a diagram depicting an example scenario for the timing of monitoring data and the timing of inference output in accordance with implementations of the present disclosure.

FIG. 15 is a block diagram of an example communication system in accordance with an implementation of the present disclosure.

FIG. 16 is a flowchart of an example process in accordance with an implementation of the present disclosure.

FIG. 17 is a flowchart of an example process in accordance with another implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes, and/or solutions pertaining to artificial intelligence (AI) mobility configuration with respect to user equipment (UE) and network apparatus in mobile communications. According to the present disclosure, a number of possible solutions may be implemented separately or jointly. That is, although these possible solutions may be described below separately, two or more of these possible solutions may be implemented in one combination or another.

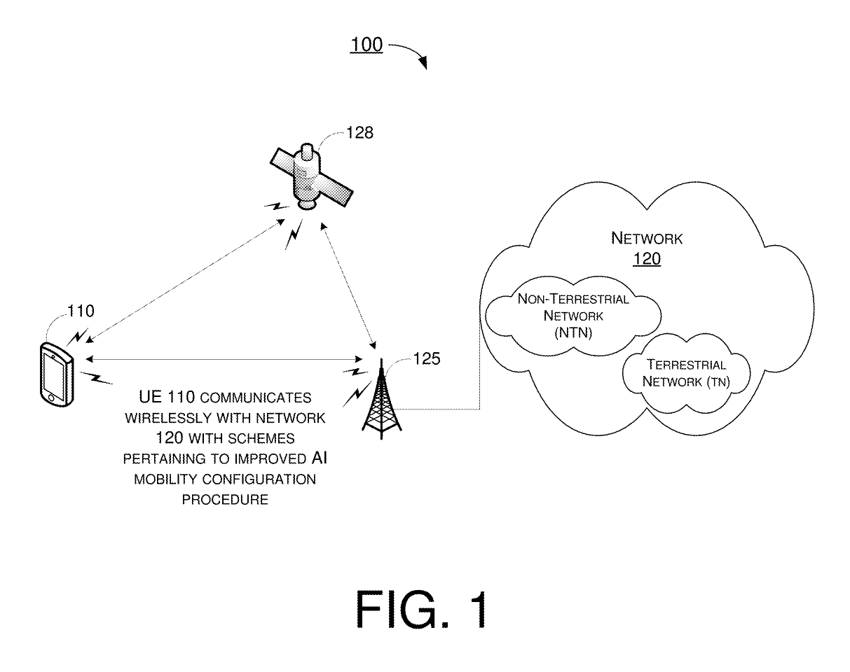

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 125 (e.g., an evolved Node-B (eNB), a Next Generation Node-B (gNB), or a transmission/reception point (TRP)) and/or a non-terrestrial network node 128 (e.g., a satellite). For example, the terrestrial network node 125 and/or the non-terrestrial network node 128 may form a non-terrestrial network (NTN) serving cell for wireless communication with the UE 110. In some implementations, the UE 110 may be an IoT device such as an NB-IoT UE or an enhanced machine-type communication (eMTC) UE (e.g., a bandwidth reduced low complexity (BL) UE or a coverage enhancement (CE) UE). In such a communication environment, the UE 110, the network 120, the terrestrial network node 125, and the non-terrestrial network node 128 may implement various schemes pertaining to improved AI mobility configuration procedures in accordance with the present disclosure, as described below. It is noteworthy that, while the various proposed schemes may be individually or separately described below, in actual implementations, some or all of the proposed schemes may be utilized or otherwise implemented jointly. Of course, each of the proposed schemes may be utilized or otherwise implemented individually or separately.

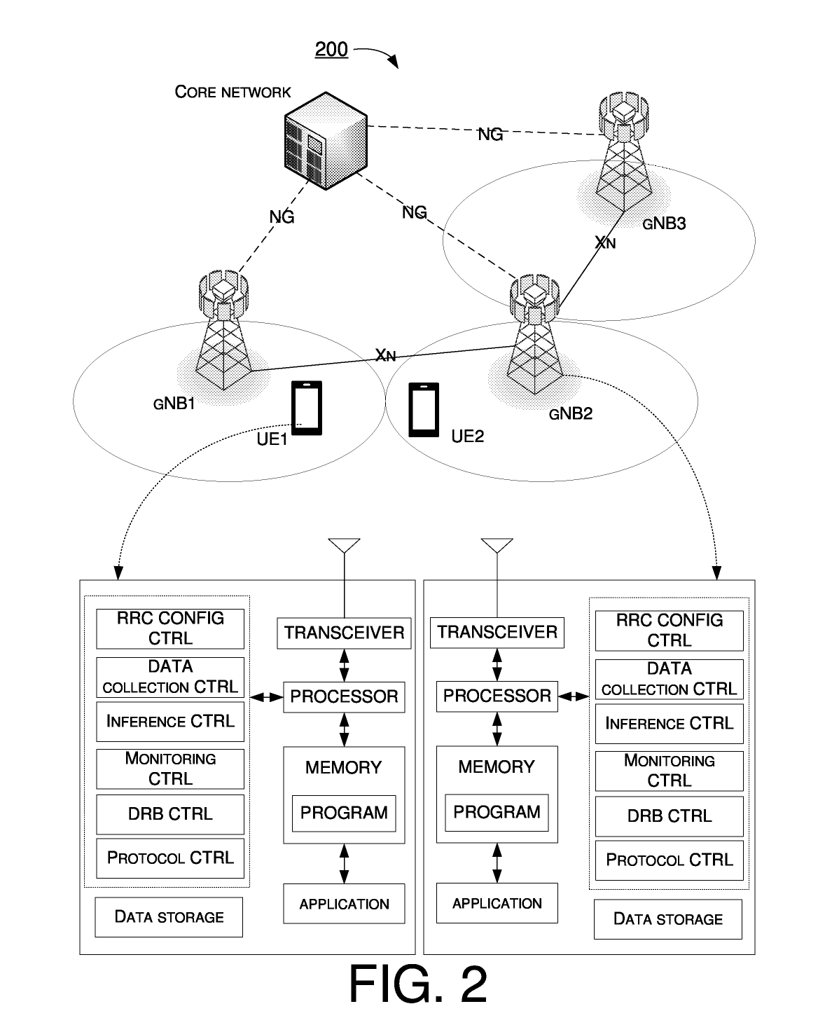

FIG. 2 illustrates an example scenario 200 for a communication system in accordance with implementations of the present disclosure. Scenario 200 involves a plurality of apparatuses (e.g., UE1 and UE2) and a plurality of network nodes (e.g., (macro/micro) base station, TRP (e.g., gNB1, gNB2, and gNB3)) of a wireless network (e.g., an LTE network, a 5G/NR network, an IoT network, or a 6G network). Referring to FIG. 2, the communication system may comprise one or more fixed base infrastructure units (or network nodes) forming a network distributed over a geographical region. The base unit may be referred to as an access point, an access terminal, a base station, an NB, an eNB, a gNB, or by other terminology used in the art. For example, the network node (e.g., gNB1, gNB2, and gNB3) may serve a number of mobile stations (e.g., UE1 and UE2) within a serving area, for example, a cell, or within a cell sector. In some implementations, one or more network nodes may be coupled to a controller forming an access network that is coupled to one or more core networks. For example, the gNB1and gNB2 may be network nodes in NR, and the serving area of which may or may not overlap with each other. The UE1 may be only in the service area of the gNB1 and connected with the gNB1. The UE1 may be connected with the gNB1 only, and the gNB2 may be connected with the gNB1 and gNB2 via the Xn interface. The UE2 may be in the overlapping service area of the gNB1 and the gNB2.

In addition, referring to FIG. 2, the apparatus (e.g., UE1 and UE2) may be referred to as a mobile station, a mobile terminal, a mobile phone, a smartphone, a wearable device, an IoT device, a tablet, a laptop, or other terminology used in the art. Each apparatus (or network node) may have an antenna that transmits and receives radio signals. A radio frequency (RF) transceiver may be coupled with the antenna. The RF transceiver may receive RF signals from the antenna, convert the RF signals to baseband signals, and transmit the baseband signals to the processor. The processor may process the received baseband signals and invoke different functional modules to perform the features in the apparatus. The memory may store program instructions, data, inference, and monitoring to control the operations of the apparatus. The apparatus (or network node) may also include multiple function modules that carry out different tasks in accordance with implementations of the present disclosure. The apparatus (or network node) may also include an application layer and a data storage that stores the collected data and the assistance information.

The radio resource control (RRC) configuration controller (config CTRL) may control the RRC message transmitted or received between the apparatus and the network node.

The state controller may control the UE RRC state according to the command of the network node and the UE conditions. The RRC may support the following states: RRC_IDLE, RRC_CONNECTED, and RRC_INACTIVE.

The data radio bearer (DRB) controller may be used to establish, add, reconfigure, modify, release, and remove a DRB based on different sets of conditions for DRB establishment, reconfiguration, and release.

The protocol stack controller may be used to manage (e.g., add, modify, or remove) the protocol stack for the DRB. The protocol Stack may comprise service data adaptation protocol (SDAP), packet data convergence protocol (PDCP), radio link control (RLC), medium access control (MAC), and physical (PHY) layers.

The data collection controller may control the data collection behavior, including the UE measurement procedure, the storage of the collected data, and the report/delivery of the collected data.

The inference controller may be used to perform model inference based on the received network (NW) configuration.

The monitoring controller may be used to perform model monitoring and report based on the received NW configuration.

Similarly, referring to FIG. 2, the gNB2 may also have an antenna that transmits and receives radio signals. An RF transceiver may be coupled with the antenna to receive RF signals from the antenna, convert the RF signals to the baseband signals, and transmit the baseband signals to the processor. The RF transceiver may also convert the received baseband signals from the processor, convert the received baseband signals to RF signals, and transmit the RF signals to the antenna. The processor may process the received baseband signals and invoke different functional modules to perform features in the gNB2. The memory may store program instructions and data for controlling the operations of the gNB2.

According to the implementations of the present disclosure, an apparatus (e.g., UE 110) may receive a configuration for AI mobility from a network node (e.g., terrestrial network node 125). The configuration may comprise a training data configuration, an inference configuration, and a monitoring configuration. Then, the apparatus may perform a measurement according to the configuration. In addition, the network node may receive a measurement report from the apparatus based on the configuration.

In the implementations of the present disclosure, the necessary modification of the radio resource management (RRM) measurement framework for AI mobility may be provided, e.g., the training data configuration which specify the collected data and logged condition, the inference configuration which specifies the measure object (related to AI Model input), the predicted object (related to AI Model output), the report configuration, and the monitoring configuration which specifies the ground-truth data and the report configuration. In addition, in the implementations of the present disclosure, the apparatus and mechanisms are provide for a UE to support data collection configuration and logged data during the UE mobility for wireless communication systems.

According to the implementations of the present disclosure, the training data configuration may comprise training data identification (ID) information, measurement object information, and a logged configuration.

According to the implementations of the present disclosure, the training data ID configuration may be used to identify a training data collection configuration and provide mapping information between the measurement object information and the logged configuration. The training data ID configuration may comprise a list of training data identities to add or modify.

According to the implementations of the present disclosure, the logged configuration may comprise at least one of a logged ID information, a condition for the apparatus to log data, a logged type, and a logged quantity cell information.

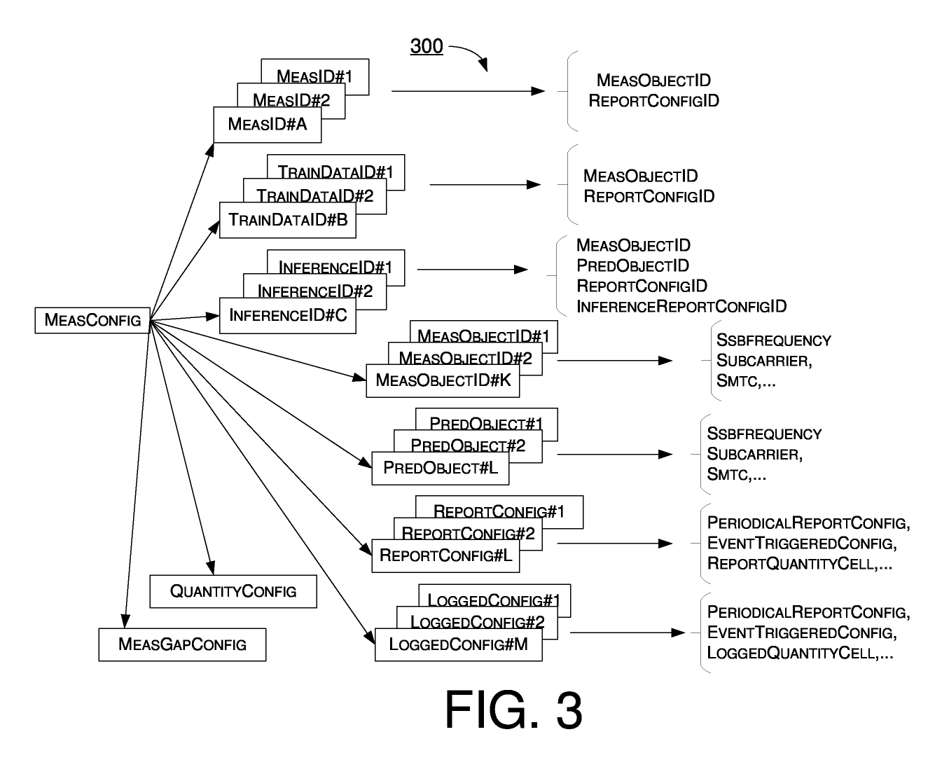

FIG. 3 illustrates an example scenario 300 for a configuration structure in accordance with implementations of the present disclosure. Referring to FIG. 3, the overall structure may reuse the legacy measurement configuration framework with certain modifications. In one implementation, the training data configuration may be configured to specify the collected data and the logged condition. In one implementation, the TrainDataId (e.g., TrainDataId#1, TrainDataId#2, …, and TrainDataId#A) may be taken as an identifier and configured to provide the mapping of a measurement object and the corresponding logged configuration. In one implementation, the inference configuration may be configured to specify the measure object (related to AI model input), the predicted object (related to AI model output), and the report configuration. For example, the InferenceId (e.g., InferenceId#1, InferenceId#2, …, and InferenceId#C) may be used as an identifier and configured to provide the mapping of a measurement object, a predicted object, a report configuration, and an inference report configuration. In an implementation, the inference report configuration may reuse the same structure as the report configuration. In another implementation, the inference report configuration may be restructured, e.g., the inference report configuration may further include cluster-based cell information. In an implementation, the predicted object may provide the information of the predicted target. For example, the PredObject (e.g., PredObject#1, PredObject#2, …, and PredObject#L) may share the same structure as the legacy MeasObject (e.g., MeasObject#1, MeasObject#2, …, and MeasObject#K) configuration, which may contain the information of timing location, frequency location, subcarrier, cell list, etc. In another example, the PredObject (e.g., PredObject#1, PredObject#2, …, and PredObject#L) may have different structure from the legacy MeasObject (e.g., MeasObject#1, MeasObject#2, …, and MeasObject#K) configuration, which contains the information of timing location, frequency location, subcarrier, cell list, etc., and further contains cluster information. In an implementation, the logged configuration may reuse the structure of the legacy ReportConfig (e.g., ReportConfig#1, ReportConfig#2, …, and ReportConfig#L), which contains the information of the condition for the UE to log data. In an implementation, the loggedType may provide the triggering type, e.g., periodical or event-triggered. For example, the loggedType may provide the type of collected data from the target cell within loggedQuantityCell, e.g., layer 1 (L1) cell reference signal received power (RSRP), layer 3 (L3) cell RSRP, L3 beam RSRP, received signal strength indication (RSSI), signal-to-interference-plus-noise ratio (SINR), etc.

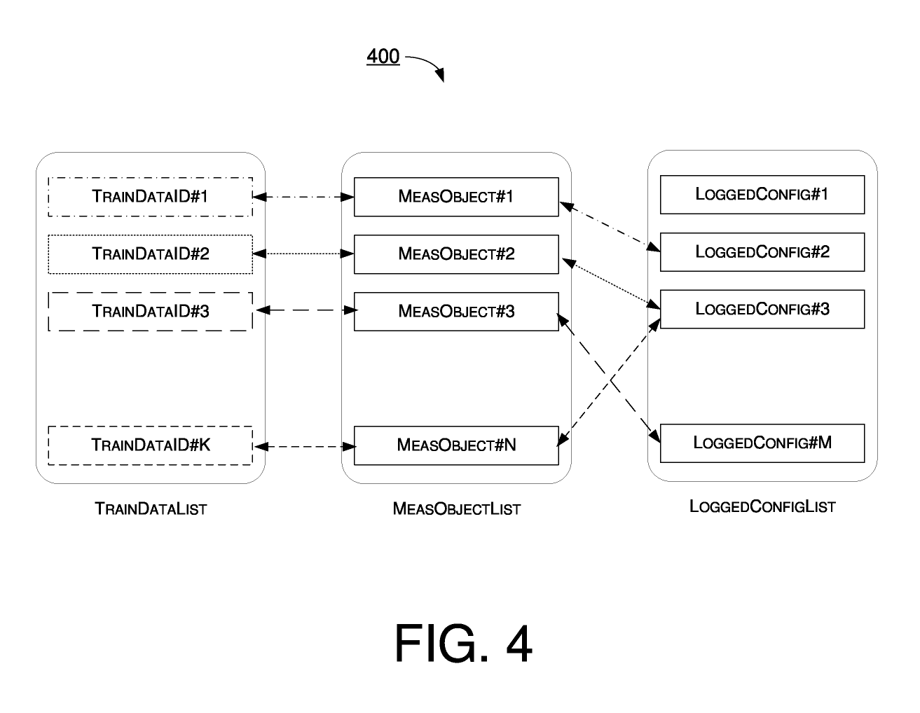

FIG. 4 illustrates an example scenario 400 for a mapping for training data configuration in accordance with implementations of the present disclosure. Referring to FIG. 4, the network node may configure TrainDataId (e.g., TrainDataId#1, TrainDataId#2, TrainDataId#3, …, and TrainDataId#K), which is used to identify a training data collection configuration and provide the mapping of a measurement object and the corresponding logged configuration. For example, referring to FIG. 4, the TrainDataId#1 may map to MeasObject#1, and MeasObject#1 may map to loggedConfig#2. The TrainDataId#2 may map to MeasObject #2, and MeasObject #2 may map to loggedConfig #3. The TrainDataId#3 may map to MeasObject#3, and MeasObject#3 may map to loggedConfig#M. The TrainDataId#K may map to MeasObject#N, and MeasObject#N may map to loggedConfig#3.

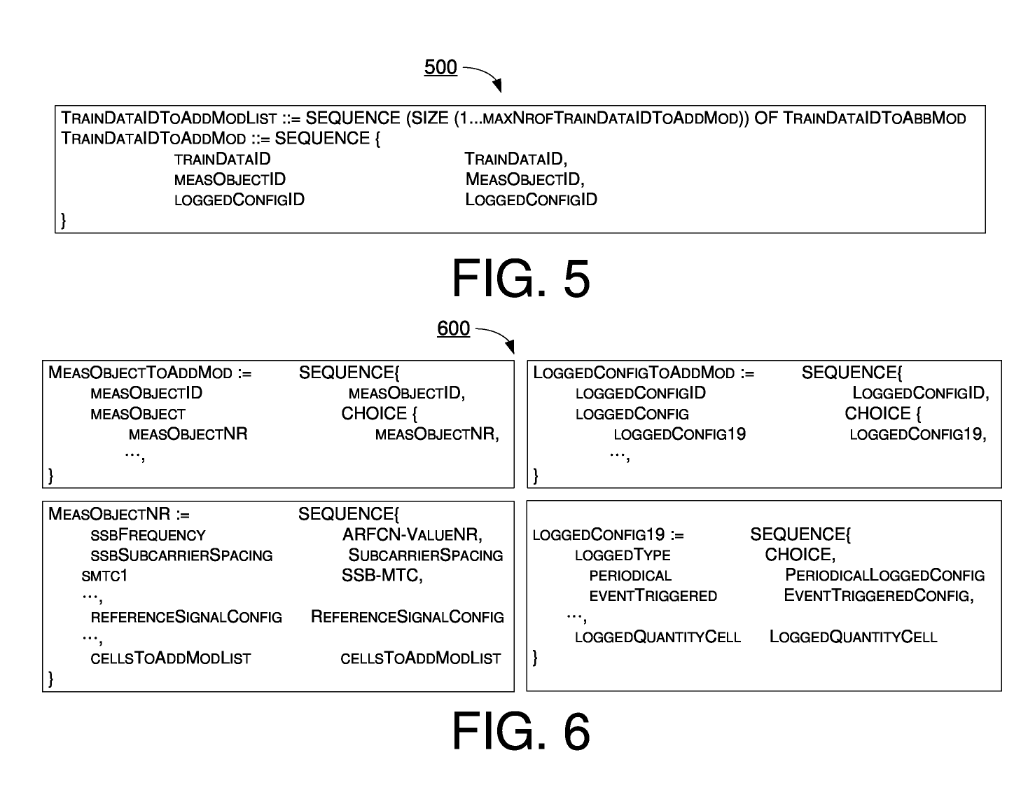

FIG. 5 illustrates an example scenario 500 for a structure for configuration of TrainDataIdToAddModList and TrainDataIdToAddMod in accordance with implementations of the present disclosure. Referring to FIG. 5, in an implementation, the TrainDataIdToAddMod may be the train data identifiers to add or modify, with for each entry the TrainDataId, the associated MeasObject with MeasObjectId, and logged configuration with LoggedConfigId. In an implementation, the TrainDataIdToAddModList may concern a list of train data identifiers to add or modify.

FIG. 6 illustrates an example scenario 600 for a configuration of MeasObject and LoggedConfig in accordance with implementations of the present disclosure. Referring to FIG. 6, the information of the data collection target may be provided in MeasObject. In one implementation, the legacy information element (IE) MeasObjectId may be reused to identify measurement object configuration. In one implementation, the legacy measurement object configuration may be reused, which provides the necessary information of data collection target, e.g., synchronization signal block (SSB) frequency, SSB-based measurement timing configuration (SMTC), reference signal (RS) configuration, cell list, etc. In one implementation, the LoggedConfigId may be used to identify the logged configuration, which is indicated by the LoggedConfig. In one implementation, the LoggedConfig may provide the information of the condition for the apparatus to log data. In one implementation, the LoggedConfig may include the loggedType which provides the triggering type, i.e., periodical (PeriodicalLoggedConfig) or event triggered (EventTriggerConfig). In one implementation, the LoggedConfig may include the loggedQuantityCell, which provides the information of collected data, e.g., L1 cell RSRP, L3 cell RSRP, L3 beam RSRP, RSSI, SINR, etc. For AI or machine learning (ML) model training, the data collection may primarily occur in RRC_CONNECTED state, where network-based timestamping remains feasible. However, if the logging triggering type is Event-Triggered, when the apparatus autonomously starts logging due to a configured event (e.g., signal quality below a threshold), the network node cannot predict the event trigger timing. The apparatus must timestamp the first sample at logging initiation. In another scenario, the logging is condition based e.g., buffer/power constraints, if logging pauses due to a full buffer or low-power state, the apparatus may timestamp the first sample upon resuming. The apparatus (or UE)-generated timestamps may be essential in these specific scenarios to ensure temporal continuity despite interruptions. In one implementation, the apparatus may provide an absolute timestamp on the first data sample when it starts or resumes data logging. In another implementation, the apparatus may provide an absolute time stamp for each data sample.

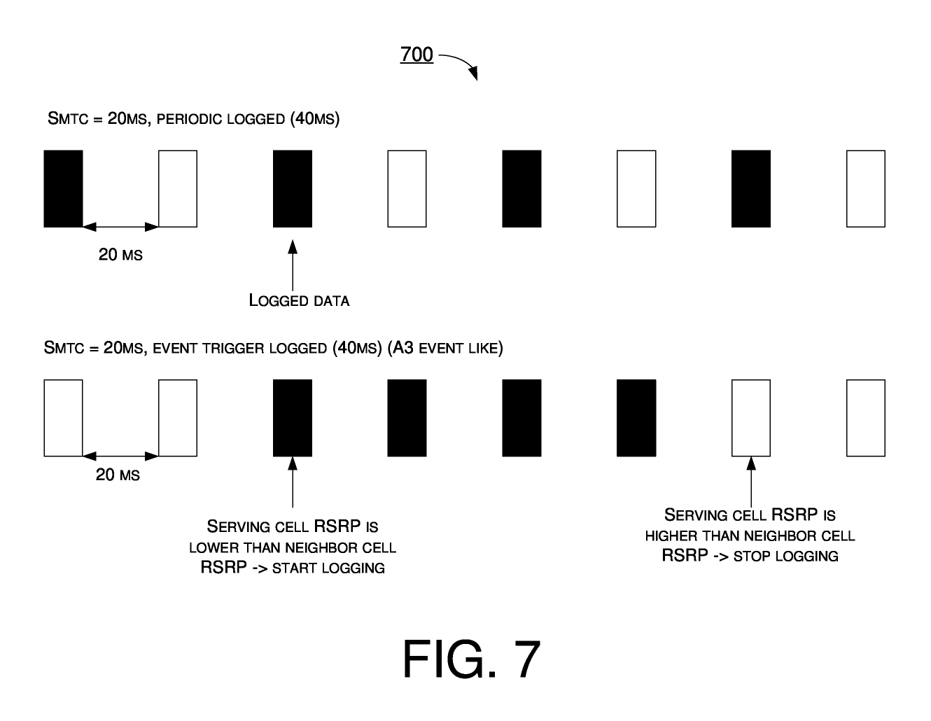

FIG. 7 illustrates an example scenario 700 for procedures for periodical logged and event trigger logged during UE mobility in accordance with implementations of the present disclosure. Referring to FIG. 7, in an implementation, the apparatus may be configured to log data periodically. For example, a measurement object with SMTC, which is 20 milliseconds (ms), and the logged condition with a period of 40 ms are configured. In another implementation, the logged condition may be event-trigger, e.g., A3-event. For example, a measurement object with SMTC, which is 20 ms, and the A3-event-like condition, i.e., when serving cell RSRP is less than the neighbor cell with a given threshold, are configured.

According to the implementations of the present disclosure, the inference configuration may comprise inference ID information, measurement object information, predicted object information, a report configuration, and an inference report configuration.

According to the implementations of the present disclosure, the inference ID information may be used to identify the inference configuration and provide mapping information among the measurement object information, the predicted object information, the report configuration, and the inference report configuration. The inference ID information may comprise information for adding or modifying the inference configuration.

According to the implementations of the present disclosure, the predicted object information may comprise information of a predicted target.

According to the implementations of the present disclosure, the inference report configuration may comprise information of an inference report condition, a report type, and a report quantity.

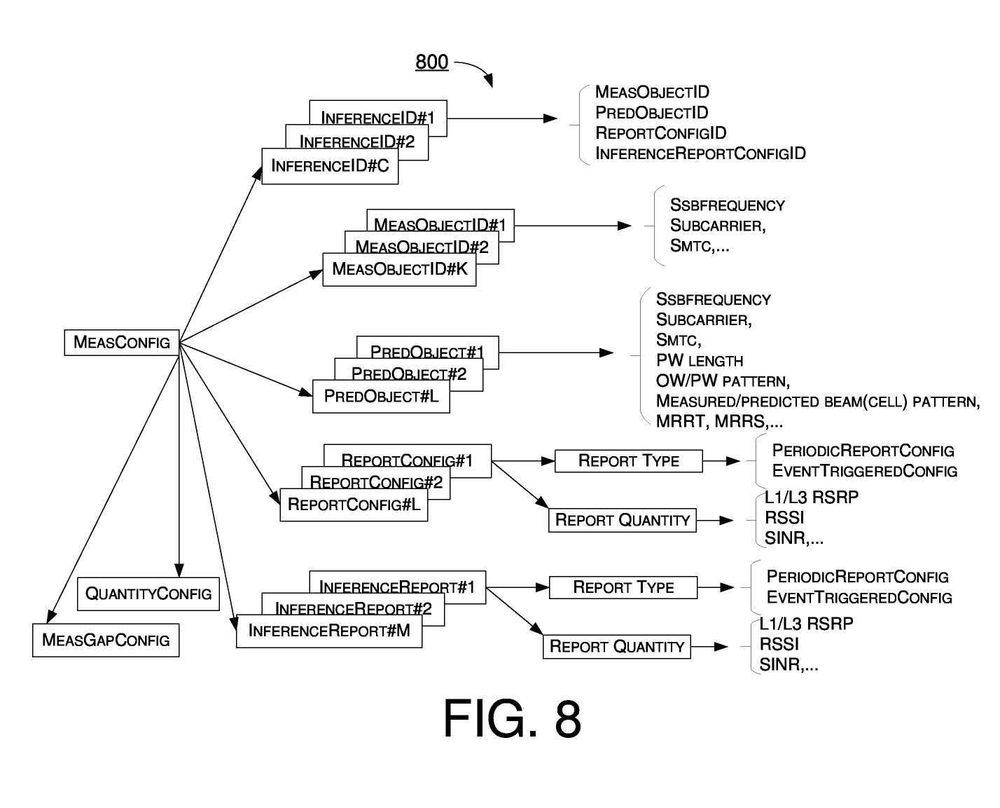

FIG. 8 illustrates an example scenario 800 for a structure of inference configuration in accordance with implementations of the present disclosure. Referring to FIG. 8, the network node may configure InferenceId (e.g., InferenceId#1, InferenceId#2, …, and InferenceId#C), which is used to identify the inference configuration and provide the mapping of a measurement object, a predicted object, a report configuration, and an inference report configuration. The MeasObject (e.g., MeasObject#1, MeasObject#2, …, and MeasObject#K) may provide information of the measurement target, which includes the timing and frequency locations, cells list, etc. The PredObject (e.g., PredObject#1, PredObject#2, …, and PredObject#L) may provide information of predict target, which includes timing and frequency location, prediction window (PW) length, observation window (OW) or PW pattern, measurement reduction ratio in temporal domain (MRRT), etc. The ReportConfig (e.g., ReportConfig#1, ReportConfig#2, …, and ReportConfig#L) may provide information on a measurement report (e.g., the report can be generated with both measurement and inference results). In an implementation, the Reportconfig and InferenceReportConfig may comprise the information of reporting triggering condition, i.e., periodical or event triggered, and the information of report quantity (via ReportQuantityCell), e.g., L1 cell RSRP, L3 cell RSRP, L3 beam RSRP, RSSI, SINR, etc. The InferenceReportConfig (e.g., InferenceReportConfig#1, InferenceReportConfig#2, …, and InferenceReportConfig#L) may provide information on an inference report (for NW side monitoring). In an implementation, the inference report condition may be provided in the ReportConfig and InferenceReportConfig with the same structure. In another implementation, the inference report condition may be provided in the InferenceReportConfig with a different structure from the ReportConfig, e.g., the InferenceReportConfig may further comprise more cluster-based cell information.

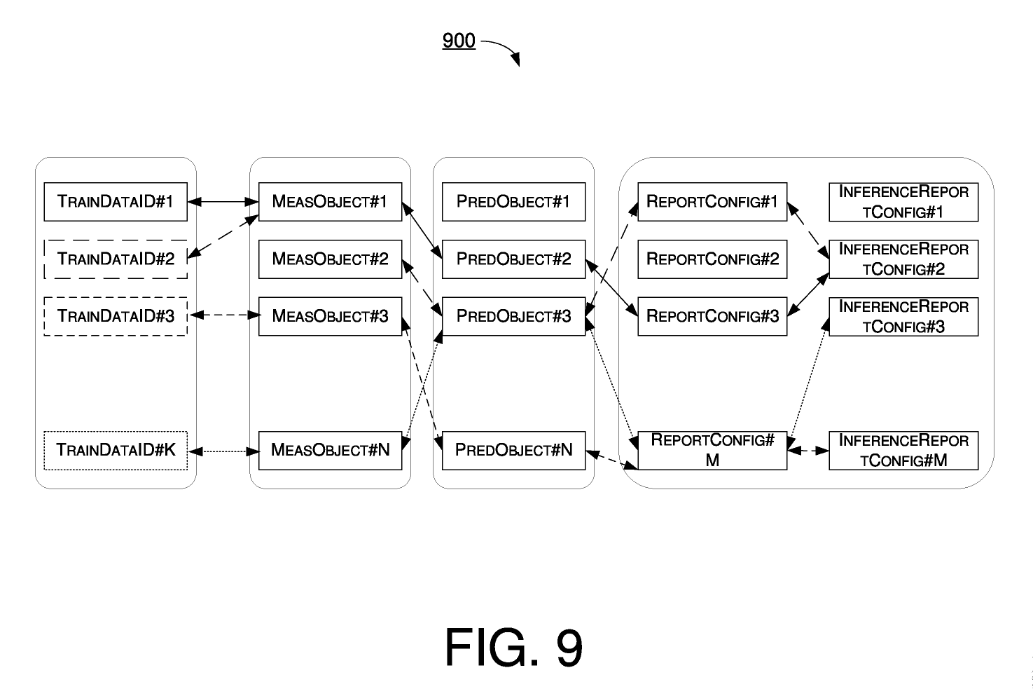

FIG. 9 illustrates an example scenario 900 for a mapping for inference configuration in accordance with implementations of the present disclosure. Referring to FIG. 9, the network node may configure InferenceId (InferenceId#1, InferenceId#2, InferenceId#3, …, and InferenceId#K), which is used to identify the inference configuration and provide the mapping of a measurement object, a predicted object, a report configuration, and an inference report configuration. For example, as shown in FIG. 9, the InferenceId#1 may map to the MeasObject#1, the MeasObject#1 may map to PredObject#2, and the PredObject#2 may map to reportConfig#3 with InfereceRportConfig#2. The InferenceId#2 may map to the MeasObject#1, the MeasObject#1 may map to PredObject#3, and the PredObject#3 may map to reportConfig#1 with InfereceRportConfig#2. The InferenceId#3 may map to the MeasObject#1, the MeasObject#1 may map to PredObject#2, and the PredObject#2 may map to reportConfig#3 with InfereceRportConfig#2. The InferenceId#K may map to the MeasObject#N, the MeasObject#N may map to the PredObject#3, and the PredObject#3 may map to reportConfig#M with InfereceRportConfig#M.

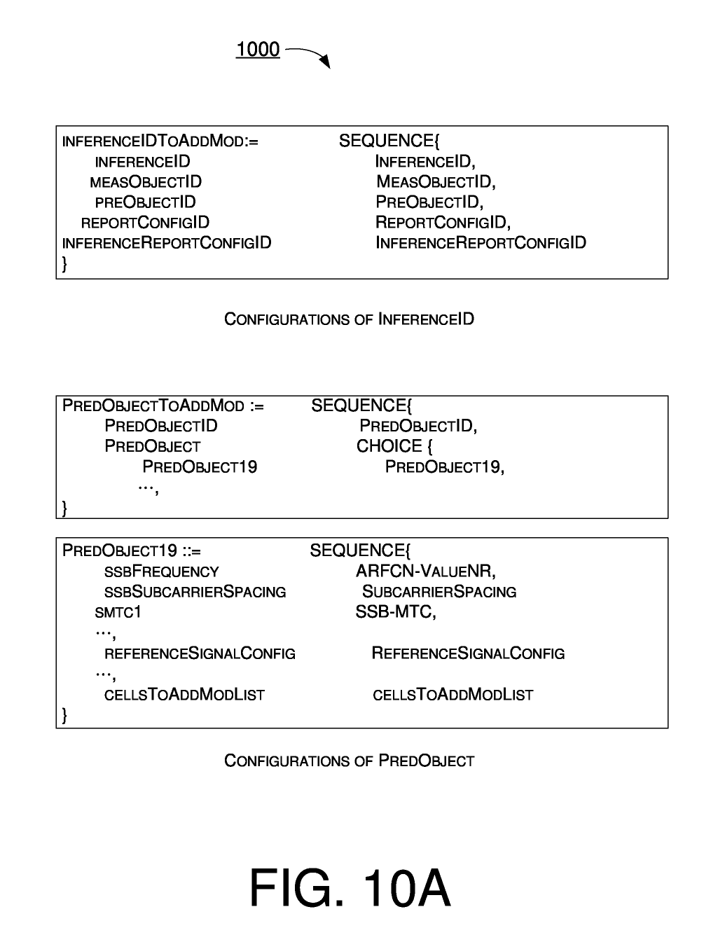

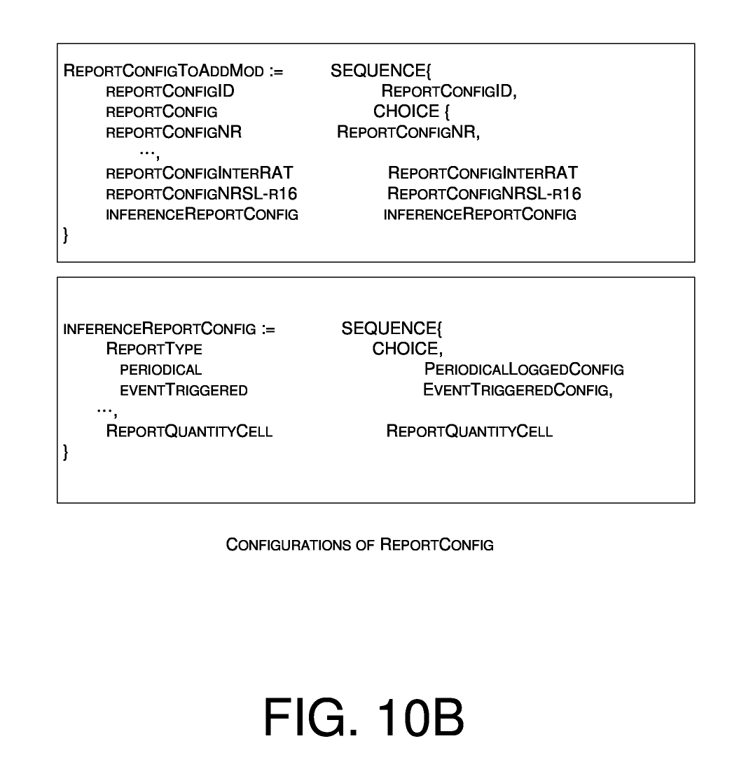

FIG. 10A-10B illustrate an example scenario 1000 for a structure for configurations of InferenceIdToAddMod, predObjectId, and ReportConfigId in accordance with implementations of the present disclosure. Referring to FIG. 10A, for the configurations of InferenceId, the InferenceIdToAddMod may comprise the inference configuration identifiers to add or modify, with the InferenceId, the associated MeasObject with MeasObjectId, the predicted object with predObjectId, the report configuration with ReportConfigId, and the inference report configuration with InferenceReportConfigId. In addition, referring to FIG. 10A, for the configurations of PredObject, in an implementation, the measurement object and predicted object may belong to the measObjectList and the predObjectList, respectively. In another implementation, the measurement object and predicted object may share the same measObjectList, which contains the information of timing location, frequency location, subcarrier, cell list, etc. In addition, referring to FIG. 10B, for the configurations of ReportConfig, in an implementation, the report condition may be provided in the ReportConfig and the InferenceReportConfig with the same structure. In another implementation, the report condition may be provided in the ReportConfig and the InferenceReportConfig with different structures. The ReportConfig may be used for the measurement report. The report can be generated based on both the real measurement and the inference result. The InferenceReportConfig may be used for the inference output report. The inference report can be used for NW sided model monitoring. In an implementation, the ReportConfig and the InferenceReportConfig may contain the information of the report triggering condition, e.g., periodical (PeriodicalReportConfig) and event-triggered (EventTriggerConfig). In an implementation, the ReportConfig and the InferenceReportConfig may contain the information of report quantity (via ReportQuantityCell), e.g., L1 cell RSRP, L3 cell RSRP, L3 beam RSRP, RSSI, SINR, etc.

According to the implementations of the present disclosure, the monitoring configuration may comprise monitor ID information, measurement object information, inference ID information, and a report configuration.

According to the implementations of the present disclosure, the monitor ID information may be used to identify the monitoring configuration and provide a mapping among the measurement object information, the inference ID information, and the report configuration. The monitor ID information may comprise information for adding or modifying the monitoring configuration.

FIG. 11 illustrates an example scenario 1100 for a structure of monitoring configuration in accordance with implementations of the present disclosure. Referring to FIG. 11, the network node may configure MonitorId (e.g., MonitorId#1, MonitorId#2, …, and MonitorId#C), which is used to identify a monitoring configuration and provide the mapping of a measurement object, an inference configuration, and a report configuration. The MeasObject (e.g., MeasObject#1, MeasObject#2, …, and MeasObject#K) may provide information of the measurement target, which includes the timing and frequency locations, cells list, etc. In an implementation, the ReportConfig may provide information of the measurement report (the measurement of monitor data or ground-truth data). In an implementation, the MonitorReportConfig (MonitorReportConfig#1, MonitorReportConfig#2, …, and MonitorReportConfig#M) may provide the report trigger condition (e.g., the PeriodicalReportConfig or the EventTriggeredConfig), the report quantity (e.g., L1/L3 RSRP, RSSI, SINR…), and the monitoring criteria (e.g., RSRP difference, F1 score, etc.).

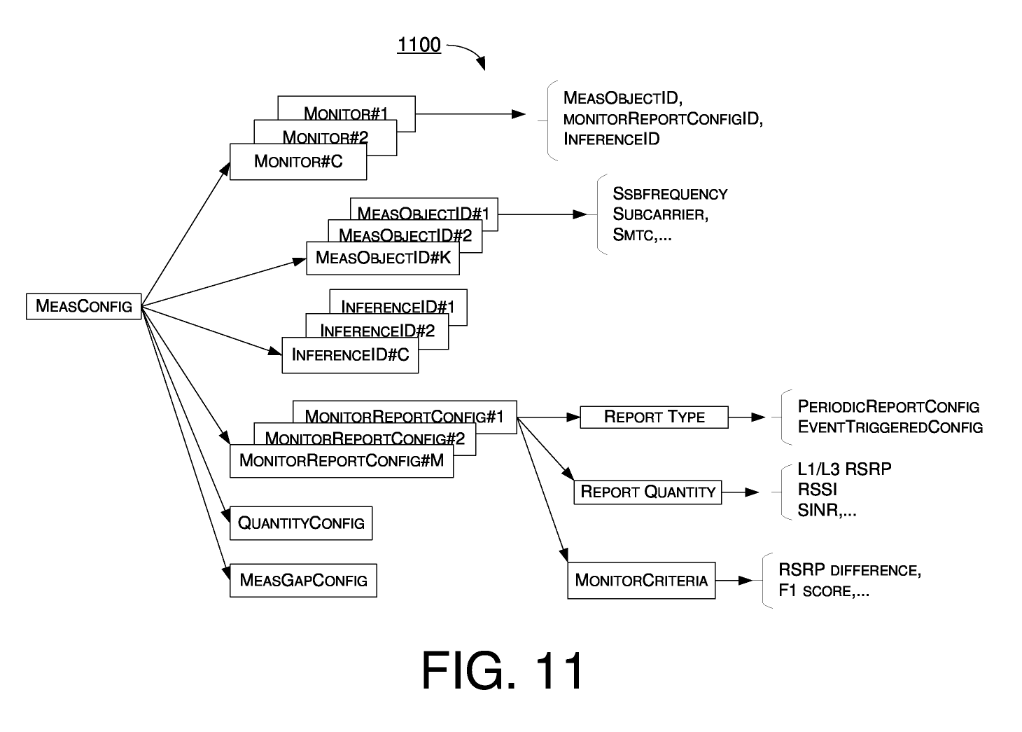

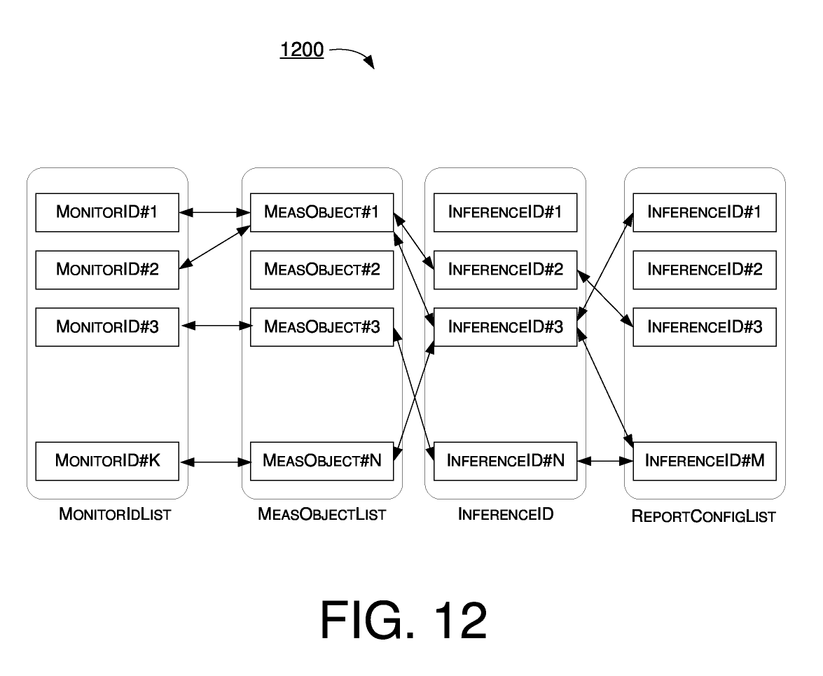

FIG. 12 illustrates an example scenario 1200 for a mapping for monitoring configuration in accordance with implementations of the present disclosure. Referring to FIG. 12, the network node may configure the MonitorId (e.g., MonitorId#1, MonitorId#2, MonitorId#3, …, and MonitorId#K), which is used to identify a monitoring configuration and provide the mapping of a measurement object, an inference configuration, and a report configuration. For example, as shown in FIG. 12, the MonitorId#1 may map to the MeasObject#1, the MeasObject#1 may map to the InferenceId#2, and the InferenceId#2 may map to the reportConfig#3. The MonitorId#2 may map to the MeasObject#1, the MeasObject#1 may map to the InferenceId#3, and the InferenceId#3 may map to the reportConfig#1. The MonitorId#3 may map to the MeasObject#3, the MeasObject#3 may map to the InferenceId#N, and the InferenceId#N may map to the reportConfig#M. The MonitorId#K may map to the MeasObject#N, the MeasObject#N may map to the InferenceId#3, and the InferenceId#3 may map to reportConfig#M.

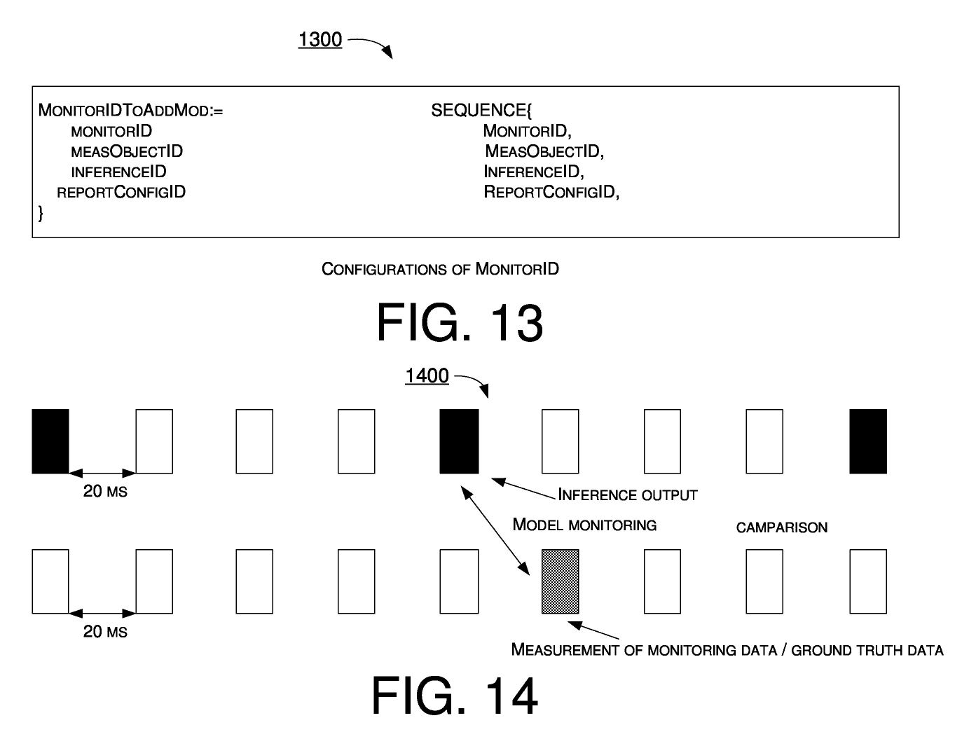

FIG. 13 illustrates an example scenario 1300 for a structure for configuration of MonitorIdToAddMod in accordance with implementations of the present disclosure. Referring to FIG. 13, the MonitorIdToAddMod may comprise the monitoring identifiers to add or modify, with for each entry of the MonitorId, the associated MeasObject with the MeasObjectId, the inference configuration with the InferenceId, and the report configuration with the reportConfigId.

FIG. 14 illustrates an example scenario 1400 for the timing of monitoring data and the timing of inference output in accordance with implementations of the present disclosure. Referring to FIG. 14, the timing of monitoring data and the timing of inference output may not be the same. In an implementation, the monitoring result may be derived by comparing the nearest inference output.

### Illustrative Implementations

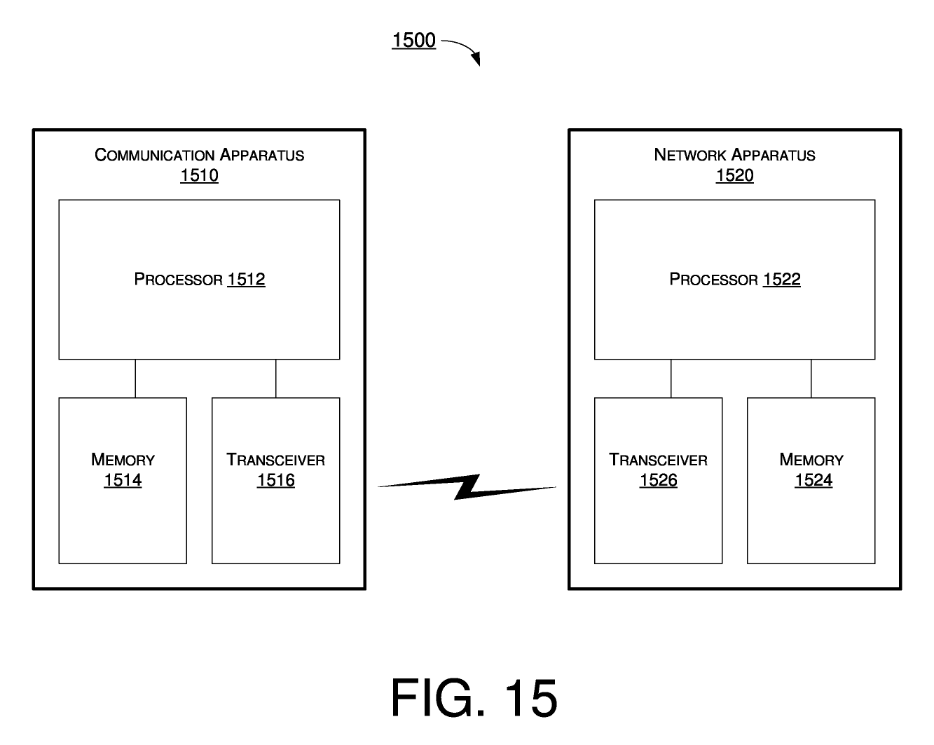

FIG. 15 illustrates an example communication system 1500 having at least an example communication apparatus 1510 and an example network apparatus 1520 in accordance with an implementation of the present disclosure. Each of communication apparatus 1510 and network apparatus 1520 may perform various functions to implement schemes, techniques, processes and methods described herein pertaining to AI mobility configuration, including the various schemes described above with respect to various proposed designs, concepts, schemes and methods described above and with respect to user equipment and network apparatus in mobile communications, including scenarios/schemes described above as well as process 1600 and process 1700 described below.

Communication apparatus 1510 may be a part of an electronic apparatus, which may be a UE such as a portable or mobile apparatus, a wearable apparatus, a wireless communication apparatus or a computing apparatus. For instance, communication apparatus 1510 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 1510 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 1510 may be implemented in a smart thermostat, a smart fridge, a smart door lock, a wireless speaker or a home control center. Alternatively, communication apparatus 1510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1510 may include at least some of those components shown in FIG. 15 such as a processor 1512, for example. Communication apparatus 1510 may further include one or more other components not pertinent to the proposed schemes of the present disclosure (e.g., internal power supply, display device and/or user interface device), and, thus, such component(s) of communication apparatus 1510 are neither shown in FIG. 15 nor described below in the interest of simplicity and brevity.

Network apparatus 1520 may be a part of an electronic apparatus, which may be a network node such as a satellite, a BS, a small cell, a router or a gateway of an IoT network. For instance, network apparatus 1520 may be implemented in a satellite or an eNB/gNB/TRP in a 4G/5G/B5G/6G, NR, IoT, NB-IoT or IIoT network. Alternatively, network apparatus 1520 may be implemented in the form of one or more IC chips such as, for example and without limitation, one or more single-core processors, one or more multi-core processors, or one or more RISC or CISC processors. Network apparatus 1520 may include at least some of those components shown in FIG. 15 such as a processor 1522, for example. Network apparatus 1520 may further include one or more other components not pertinent to the proposed scheme of the present disclosure (e.g., internal power supply, display device and/or user interface device), and, thus, such component(s) of network apparatus 1520 are neither shown in FIG. 15 nor described below in the interest of simplicity and brevity.

In one aspect, each of processor 1512 and processor 1522 may be implemented in the form of one or more single-core processors, one or more multi-core processors, or one or more CISC processors. That is, even though a singular term “a processor” is used herein to refer to processor 1512 and processor 1522, each of processor 1512 and processor 1522 may include multiple processors in some implementations and a single processor in other implementations in accordance with the present disclosure. In another aspect, each of processor 1512 and processor 1522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1512 and processor 1522 is a special-purpose machine specifically designed, arranged and configured to perform specific tasks, including AI mobility cconfiguration, in a device (e.g., as represented by communication apparatus 1510) and a network node (e.g., as represented by network apparatus 1520) in accordance with various implementations of the present disclosure.

In some implementations, communication apparatus 1510 may also include a transceiver 1516 coupled to processor 1512 and capable of wirelessly transmitting and receiving data. In some implementations, transceiver 1516 may be capable of wirelessly communicating with different types of UEs and/or wireless networks of different radio access technologies (RATs). In some implementations, transceiver 1516 may comprise a main receiver and a low-power receiver. In some implementations, transceiver 1516 may be equipped with a plurality of antenna ports (not shown) such as, for example, four antenna ports. That is, transceiver 1516 may be equipped with multiple transmit antennas and multiple receive antennas for multiple-input multiple-output (MIMO) wireless communications. In some implementations, network apparatus 1520 may also include a transceiver 1526 coupled to processor 1522. Transceiver 1526 may include a transceiver capable of wirelessly transmitting and receiving data. In some implementations, transceiver 1526 may be capable of wirelessly communicating with different types of UEs of different RATs. In some implementations, transceiver 1526 may be equipped with a plurality of antenna ports (not shown) such as, for example, four antenna ports. That is, transceiver 1526 may be equipped with multiple transmit antennas and multiple receive antennas for MIMO wireless communications.

In some implementations, communication apparatus 1510 may further include a memory 1514 coupled to processor 1512 and capable of being accessed by processor 1512 and storing data therein. In some implementations, network apparatus 1520 may further include a memory 1524 coupled to processor 1522 and capable of being accessed by processor 1522 and storing data therein. Each of memory 1514 and memory 1524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1514 and memory 1524 may include a type of read-only memory (ROM) such as mask ROM, programmable ROM (PROM), erasable programmable ROM (EPROM) and/or electrically erasable programmable ROM (EEPROM). Alternatively, or additionally, each of memory 1514 and memory 1524 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 1510 and network apparatus 1520 may be a communication entity capable of communicating with each other using various proposed schemes in accordance with the present disclosure. For illustrative purposes and without limitation, descriptions of capabilities of communication apparatus 1510, as a UE, and network apparatus 1520, as a network node (e.g., TRP), are provided below with process 1600 and process 1700.

### Illustrative Processes

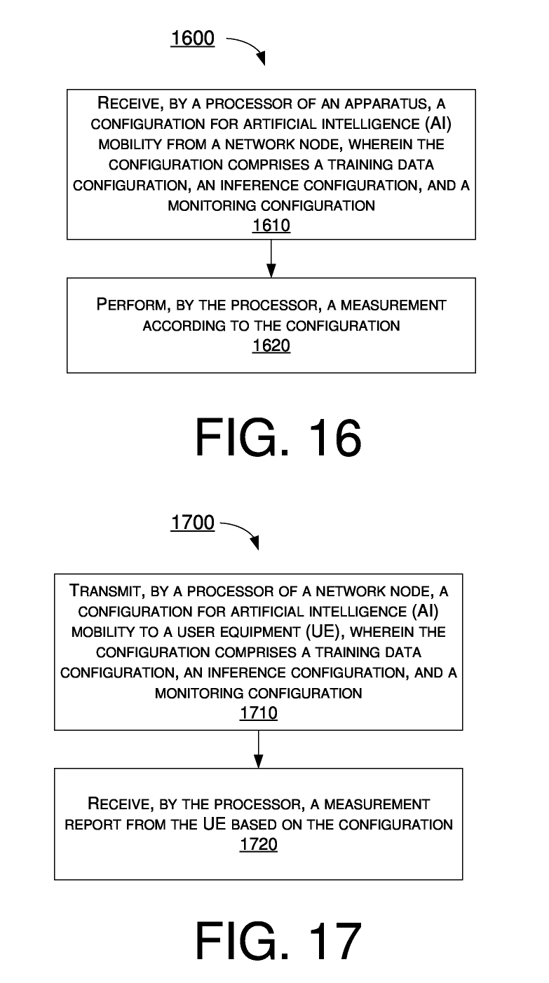

FIG. 16 illustrates an example process 1600 in accordance with an implementation of the present disclosure. Process 1600 may be an example implementation of above scenarios/schemes, whether partially or completely, with respect to AI mobility configuration with the present disclosure. Process 1600 may represent an aspect of implementation of features of communication apparatus 1510. Process 1600 may include one or more operations, actions, or functions as illustrated by one or more of blocks 1610 and 1620. Although illustrated as discrete blocks, various blocks of process 1600 may be divided into additional blocks, combined into fewer blocks, or eliminated, depending on the desired implementation. Moreover, the blocks of process 1600 may be executed in the order shown in FIG. 16 or, alternatively, in a different order. Solely for illustrative purposes and without limitation, process 1600 is described below in the context of communication apparatus 1510. Process 1600 may begin at block 1610.

At block 1610, process 1600 may involve processor 1512 of communication apparatus 1510 receiving, via transceiver 1516, a configuration for AI mobility from a network node. The configuration may comprise a training data configuration, an inference configuration, and a monitoring configuration. Process 1600 may proceed from block 1610 to block 1620.

At block 1620, process 1600 may involve processor 1512 of communication apparatus 1510 performing a measurement according to the configuration.

In some implementations, the training data configuration may comprise training data ID information, measurement object information, and a logged configuration.

In some implementations, the training data ID configuration may be used to identify a training data collection configuration and provide mapping information between the measurement object information and the logged configuration. The training data ID configuration may comprise a list of training data identities to add or modify.

In some implementations, the logged configuration may comprise at least one of a logged ID information, a condition for the apparatus to log data, a logged type, and a logged quantity cell information.

In some implementations, the inference configuration may comprise inference ID information, measurement object information, predicted object information, a report configuration, and an inference report configuration.

In some implementations, the inference ID information may be used to identify the inference configuration and provide mapping information among the measurement object information, the predicted object information, the report configuration, and the inference report configuration. The inference ID information may comprise information for adding or modifying the inference configuration.

In some implementations, the predicted object information may comprise information of a predicted target.

In some implementations, the inference report configuration may comprise information of an inference report condition, a report type, and a report quantity.

In some implementations, the monitoring configuration may comprise monitor ID information, measurement object information, inference ID information, and a report configuration.

In some implementations, the monitor ID information may be used to identify the monitoring configuration and provide a mapping among the measurement object information, the inference ID information, and the report configuration. The monitor ID information may comprise information for adding or modifying the monitoring configuration.

FIG. 17 illustrates an example process 1700 in accordance with another implementation of the present disclosure. Process 1700 may be an example implementation of above scenarios/schemes, whether partially or completely, with respect to AI mobility configuration with the present disclosure. Process 1700 may represent an aspect of implementation of features of network apparatus 1520. Process 1700 may include one or more operations, actions, or functions as illustrated by one or more of blocks 1710 and 1720. Although illustrated as discrete blocks, various blocks of process 1700 may be divided into additional blocks, combined into fewer blocks, or eliminated, depending on the desired implementation. Moreover, the blocks of process 1700 may be executed in the order shown in FIG. 17 or, alternatively, in a different order. Solely for illustrative purposes and without limitation, process 1700 is described below in the context of network apparatus 1520. Process 1700 may begin at block 1710.

At block 1710, process 1700 may involve processor 1522 of network apparatus 1520 transmitting, via transceiver 1526, a configuration for AI mobility to a UE. The configuration may comprise a training data configuration, an inference configuration, and a monitoring configuration. Process 1700 may proceed from block 1710 to block 1720.

At block 1720, process 1700 may involve processor 1522 of network apparatus 1520 receiving, via transceiver 1526, a measurement report from the UE based on the configuration.

In some implementations, the training data configuration may comprise training data ID information, measurement object information, and a logged configuration.

In some implementations, the training data ID configuration may be used to identify a training data collection configuration and provide mapping information between the measurement object information and the logged configuration. The training data ID configuration may comprise a list of training data identities to add or modify.

In some implementations, the logged configuration may comprise at least one of a logged ID information, a condition for the apparatus to log data, a logged type, and a logged quantity cell information.

In some implementations, the inference configuration may comprise inference ID information, measurement object information, predicted object information, a report configuration, and an inference report configuration.

In some implementations, the inference ID information may be used to identify the inference configuration and provide mapping information among the measurement object information, the predicted object information, the report configuration, and the inference report configuration. The inference ID information may comprise information for adding or modifying the inference configuration.

In some implementations, the predicted object information may comprise information of a predicted target.

In some implementations, the inference report configuration may comprise information of an inference report condition, a report type, and a report quantity.

In some implementations, the monitoring configuration may comprise monitor ID information, measurement object information, inference ID information, and a report configuration.

In some implementations, the monitor ID information may be used to identify the monitoring configuration and provide mapping information among the measurement object information, the inference ID information, and the report configuration. The monitor ID information may comprise information for adding or modifying the monitoring configuration.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected", or "operably coupled", to each other to achieve the desired functionality, and any two components capable of being so associated can also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to implementations containing only one such recitation, even when the same claim includes the introductory phrases "one or more" or "at least one" and indefinite articles such as "a" or "an," e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of "two recitations," without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a configuration for artificial intelligence (AI) mobility from a network node, wherein the configuration comprises a training data configuration, an inference configuration, and a monitoring configuration; and
performing, by the processor, a measurement according to the configuration.

2. The method of claim 1, wherein the training data configuration comprises training data identification (ID) information, measurement object information, and a logged configuration.

3. The method of claim 2, wherein the training data ID configuration is used to identify a training data collection configuration, and provide mapping information between the measurement object information and the logged configuration, and wherein the training data ID configuration comprises a list of training data identities to add or modify.

4. The method of claim 2, wherein the logged configuration comprises at least one of a logged ID information, a condition for the apparatus to log data, a logged type, and a logged quantity cell information.

5. The method of claim 1, wherein the inference configuration comprises inference identification (ID) information, measurement object information, predicted object information, a report configuration, and an inference report configuration.

6. The method of claim 5, wherein the inference ID information is used to identify the inference configuration, and provide mapping information among the measurement object information, the predicted object information, the report configuration, and the inference report configuration, and wherein the inference ID information comprises information for adding or modifying the inference configuration.

7. The method of claim 5, wherein the predicted object information comprises information of a predicted target.

8. The method of claim 5, wherein the inference report configuration comprises information of an inference report condition, a report type, and a report quantity.

9. The method of claim 1, wherein the monitoring configuration comprises monitor identification (ID) information, measurement object information, inference ID information, and a report configuration.

10. The method of claim 9, wherein the monitor ID information is used to identify the monitoring configuration and provide a mapping among the measurement object information, the inference ID information, and the report configuration, and wherein the monitor ID information comprises information for adding or modifying the monitoring configuration.

11. A method, comprising:
transmitting, by a processor of a network node, a configuration for artificial intelligence (AI) mobility to a user equipment (UE), wherein the configuration comprises a training data configuration, an inference configuration, and a monitoring configuration; and
receiving, by the processor, a measurement report from the UE based on the configuration.

12. The method of claim 11, wherein the training data configuration comprises training data identification (ID) information, measurement object information, and a logged configuration.

13. The method of claim 12, wherein the training data ID configuration is used to identify a training data collection configuration, and provide mapping information between the measurement object information and the logged configuration, and wherein the training data ID configuration comprises a list of training data identities to add or modify.

14. The method of claim 12, wherein the logged configuration comprises at least one of a logged ID information, a condition for the apparatus to log data, a logged type, and a logged quantity cell information.

15. The method of claim 11, wherein the inference configuration comprises inference identification (ID) information, measurement object information, predicted object information, a report configuration, and an inference report configuration.

16. The method of claim 15, wherein the inference ID information is used to identify the inference configuration, and provide mapping information among the measurement object information, the predicted object information, the report configuration, and the inference report configuration, and wherein the inference ID information comprises information for adding or modifying the inference configuration.

17. The method of claim 15, wherein the predicted object information comprises information of a predicted target.

18. The method of claim 15, wherein the inference report configuration comprises information of an inference report condition, a report type, and a report quantity.

19. The method of claim 11, wherein the monitoring configuration comprises monitor identification (ID) information, measurement object information, inference ID information, and a report configuration.

20. An apparatus, comprising:
a transceiver which, during operation, communicates with a network node; and
a processor communicatively coupled to the transceiver such that, during operation, the processor performs operations comprising:
receiving, via the transceiver, a configuration for artificial intelligence (AI) mobility from the network node, wherein the configuration comprises a training data configuration, an inference configuration, and a monitoring configuration; and
performing a measurement according to the configuration.
